(19) United States
(12) Patent Application Publication
(10) Pub. No.: US 2009/0083989 A1
(43) Pub. Date: Apr. 2, 2009

(54) Flow-dividing device of blowing model for drying and ironing out clothing

(75) Inventor: Chih-Sheng Wang, Taipei City (TW)

Correspondence Address: BUCKNAM AND ARCHER, 1077 NORTHERN BOULEVARD, ROSLYN, NY, 11576, US

(73) Assignee: KUANG-HUAN FU

(21) Appl. No.: 11/986,946

(22) Filed: Nov. 27, 2007

(30) Foreign Application Priority Data
Sep. 27, 2007 (TW) 96135860

(51) Int. Cl. F26B 3/04

(52) U.S. Cl. 34/442; 34/443

(57) ABSTRACT

A flow-dividing device of a blowing model for drying and ironing out clothing, in which the blowing model is made by sewing a porous cloth to form a closed model corresponding to human body for wearing wet clothing thereon. An air inlet pipe is formed at the top of the model, and a heating device is connected to an outer end of the air inlet pipe for blowing air into the model. A plurality of flow-dividing tube are provided within the model. One end of each flow-dividing pipe is branched from an inner side of the air inlet pipe, and the other end of each flow-dividing tube is directed respectively to an inner side corresponding to a plurality of laminated portions of the clothing. Accordingly, the clothing can be uniformly dried and the drying duration can be shortened. Besides, the clothing can be maintained in an ironed state.

### BACKGROUND OF THE INVENTION

1. Field of the invention

This invention relates to a mechanism for drying and ironing out clothing by using porous human-body model, and more particularly to a flow-dividing device of a blowing model which uses flow-dividing tubes to direct hot air and accelerate the air-permeating speed of the laminated portion of clothing so as to accelerate to dry clothing and to maintain the clothing in an ironed state.

2. Brief Description of the Prior Art

Conventionally, the method of drying clothing is either done by natural sunlight or wind, or done by an electric dryer. Drying clothing by natural sunlight or wind takes a long time, especially during a bad weather condition. Moreover, the clothing after drying by natural way is easily wrinkled so that the clothing has to be ironed before wearing it. In the latter case, wet clothing are placed within a closed space of the dryer and heated so that water in the clothing is evaporated. The time needed to dry the clothing can be saved by using electric dryer, but the clothing is wrinkled all over after drying due to continuous turning in the drum during drying. Normally, it takes approximately 40 minutes to dry the pant or shirt by electric clothing dryer, and then it takes about 6 to 10 minutes for an experienced woman to iron. Therefore, both time and energy is wasted.

In order to improve the drawbacks of the conventional method and mechanism for drying and ironing out clothing, as shown in FIGS. 1a˜1c, a Taiwanese Patent No. 409157 (corresponding to U.S. Pat. No. 6,041,517) entitled “METHOD AND RELATED BLOWING MODEL FOR DRYING AND SYNCHRONOUSLY IRONING OUT CLOTHING BY USING A BLOWING MODEL” proposed by the inventor of this invention comprises: the porous cloth is sewn to a model of an upper half of human body (10′), the model (10′) contains an upper half portion of body (12′), a neck portion (11′) and an upper limbs portion (13′), and is formed a sealed type; an air-blowing pipe (14′) is installed on the top end face of neck portion (11′), a manifold (15′) is mounted in the neck portion (11′), and a branch manifold (151′) is mounted in the manifold (15′); the porous cloth is sewn to a model (20′) of a lower half of human body (21′), the model (20′) contains a lower portion of body (21′) and lower limbs portion (22′), and is formed in a sealed type; an air-blowing pipe (23′) is installed on the top end face of body; an manifold (24′) is mounted in the upper end of body (21′), and a branch manifold (241′) is mounted in the manifold; while the above described models (20′, 21′) are under non-blowing status, and are put into wet clothes (16′) and trousers (25′) respectively, then overlay the manifolds (15′, 24′) and branch-manifolds (151′, 241′) on the stack layer portion, the hot air is blown into an air-blowing pipes (14′, 23′) by using a blower (17′); after the model (10′, 20′) is maintained at a tensile force, the hot air will escape from the small slits among fibers of the porous cloth and will simultaneously take away the water molecules fibers of external layers of the clothes to quickly dry the clothes and keep the same flat-orderly.

The above Taiwanese Patent publication can undoubtedly achieve the object and effectiveness of the invention. However, the inventor of the present invention found in the process of commercialization that a pressurized zone is generated in the upper limbs portions (13′) and the lower limbs portions (22′) of the models (10′, 20′) because the speed of the hot air-permeating from inside out of the models (10′, 20′) is smaller than the speed of hot air blown from the blower (17′). This pressurized zone forms a descending resistance to the hot air such that a temperature-rising barrier in the pressurized zone is resulted and thus the temperature-homogenizing effect is not so satisfactory. Furthermore, the manifolds (15′,24′) and branched manifolds (151′,241′) are provided for the laminated portion of the clothing to enhance the permeation of hot air from outside in the laminated portion. However, it is found in the practical test that the hot air-permeating from outside in the laminated portion in the manifolds (15′,24′) and branched manifolds (151′,241′) becomes one of the reasons hindering hot air in the models (10′, 20′) from permeating from inside out. Thus, the effect of accelerating to dry the laminated portion is not as good as expected. In addition, the inventor of the present invention found in another experiment that if a flow-dividing pipe is used to guide the hot air coming from the blower to the lower ends of the upper limb portions and the lower limb portions and if the permeation speed is enhanced over the end portion, a circulation flow of hot air is generated such that the temperature homogenizing effect of hot air in the whole models will be improved significantly. In this manner, the present invention is proposed thereby.

### SUMMARY OF THE INVENTION

The main object of the present invention is to provide a flow-dividing device of blowing model for drying and ironing out clothing such that the above-mentioned drawbacks of prior art can be improved.

In order to achieve the above and other objects, a flow-dividing device of blowing model is provided, in which the blowing model is made by sewing porous cloth to form a closed model corresponding to human body for wearing wet clothing thereon, an air inlet pipe formed at the top of the model, and a heating device connected to an outer end of the air inlet pipe for blowing air into the model, wherein a plurality of flow-dividing tubes are provided within the model, one end of each flow-dividing tube is branched from the inside of the air inlet pipe, and the other end of each flow-dividing tube is directed respectively to the inner side corresponding to a plurality of laminated portions of the clothing. The blowing model has a plurality of enhanced porous regions formed by cloth having mesh density slightly larger than that of the porous cloth used for the model.

According to the present invention, the flow-dividing tubes are formed by sewing the cloth having meshes density smaller than that of the porous cloth used for the model, or by sewing an air-proof cloth. One end point of an end of each flow-dividing tube is fixed respectively on the upper edge of the inner side of the enhanced air-permeable region such that each flow-dividing tube can discharge hot air to the enhanced air-permeable region. According to the experiment, one part of the hot air directed out from each flow-dividing tube can accelerate the air-permeating speed for partial region, and the other part of the hot air diff-uses and circulates inside the model. Hence, the drying speed for the laminated portion of clothing can be accelerated. Additionally, the formation of a pressurized zone forming descending resistance to the hot air in the upper limb portions and the lower limb portions of the models is avoided. Therefore, the hot air can be more uniformly dispersed in the models.

According to the present invention, the blowing model includes: an upper half model formed by simulating upper-half human body for wearing clothing thereon; a lower half model formed by simulating lower-half human body for wearing pant thereon; and a complete model formed by simulating upper-half body and hip for wearing or hanging female body stockings such as spaghetti strap clothing, underwear, panty, sock and small accessories. An ordinary blower is used to blow hot air into the blowing model from the air inlet pipe. After the model is inflated to a certain extent of tension, the hot air begins to permeate from the gap between the cloth fibers to the outside and carry away the water molecules between the cloth fibers. Therefore, the clothing can be dried quickly. Compared with the conventional electric dryer, almost half of the time and electricity for drying consumed can be saved. Moreover, the clothing after being dried can be maintained to be ironed and orderly. This is another object of the present invention.

According to the present invention, the blowing model in an uninflated state can be folded and stocked easily like regular clothing, thus it has very high portability which is suitable for person with frequent business trip or travel or unsteady place to stay to dry and iron the clothing on a do-it-yourself fashion. This is another object of the present invention.

### BRIEF DESCRIPTION OF THE ACCOMPANYING DRAWINGS

FIG. 1a is a schematic view cited from U.S. Pat. No. 6,041,517 showing an upper-half model of human body;

FIG. 1b is a schematic view cited from U.S. Pat. No. 6,041,517 showing a lower-half model of human body;

FIG. 1c is a schematic view cited from U.S. Pat. No. 6,041,517 showing the using the state of a blowing model;

FIG. 2a is a schematic front view showing the upper half model of the present invention;

FIG. 2b is a schematic rear view showing the upper half model of FIG. 2a;

FIG. 2c is a schematic sectional view seen from the 2c-2c direction of FIG. 2a;

FIG. 2d is a schematic view showing the operating state of the upper half model in FIG. 2a.

FIG. 3a is a schematic front view showing the lower half model of the present invention;

FIG. 3b is a schematic rear view showing the lower half model of FIG. 3a;

FIG. 3c is a schematic cross-sectional view taken in line 3c-3c of FIG. 3a;

FIG. 3d is a schematic view showing the operating state of the lower half model of FIG. 3a;

FIG. 4a is a schematic front view showing the complete model of the present invention;

FIG. 4b is a schematic rear view showing the complete model of FIG. 4a;

FIG. 4c is a schematic cross-sectional view taken in line 4c-4c of FIG. 4a;

FIG. 4d is a schematic front view showing the operating state of the complete model of FIG. 4a;

FIG. 4e is a schematic rear view showing the operating state of the complete model of FIG. 4d;

FIG. 5a shows a heating device of the present invention with the connecting member disconnected;

FIG. 5b is a schematic view showing the partial operating state of the heating device of FIG. 5a in combination with the blowing model of the present invention; and

FIG. 6 is a schematic view showing the partial operating state of another heating device in combination with the blowing model of the present invention.

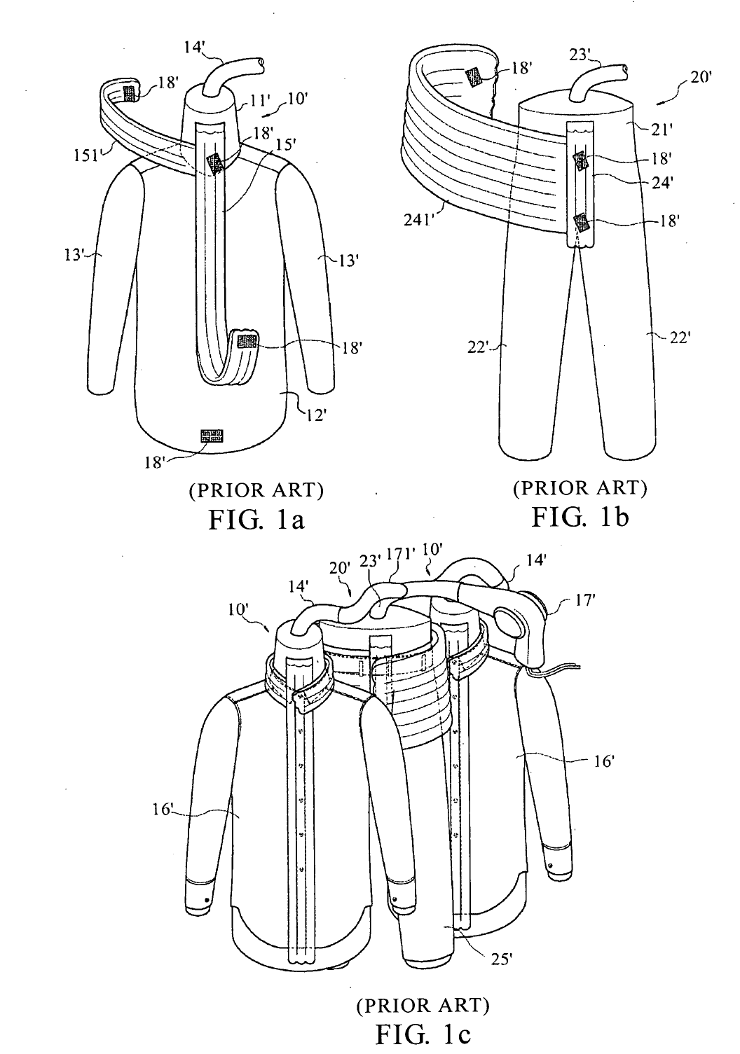

### DETAILED DESCRIPTION OF THE PREFERRED EMBODIMENTS

The technical features of the present invention will become more apparent by the detailed description of the following preferred embodiments of the present invention in conjunction with the accompanied drawings.

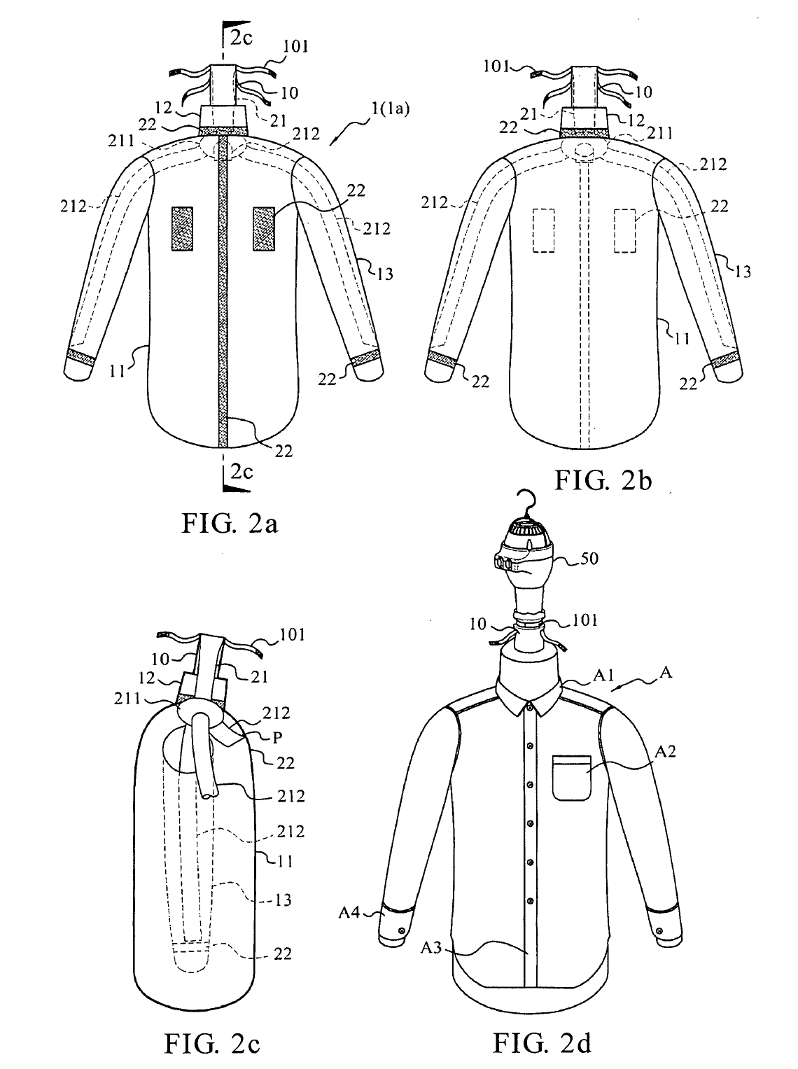

Firstly, please refer to FIGS. 2a, 3a and 4a. A flow-dividing device of the blowing model for drying and ironing out clothing of the present invention is shown, in which the blowing model 1 is made by sewing porous cloth to form a closed model corresponding to human body for wearing wet clothing thereon. An air inlet pipe 10 is formed at the top of the model 1, and a heating device 50 is connected to the outside end of the air inlet pipe 10 for blowing hot air into the model 1. A plurality of flow-dividing tubes 212 are provided within the model 1. One end of each flow-dividing tube 212 is branched from the inside of the air inlet pipe 10, and the other end of each flow-dividing tube is directed respectively to the inner side corresponding to a plurality of laminated portions of the clothing. The blowing model 1 forms a plurality of enhanced air permeable regions 22 with a cloth having meshes density slightly larger than that of the porous cloth used for the model 1 such that the air-permeating speed is accelerated. The flow-dividing tubes 212 are formed by sewing the cloth having mesh density smaller than that of the porous cloth used for the model 1 or by sewing an air-proof cloth. One end point P of an end of each flow-dividing tube is fixed respectively on the upper edge inside the enhanced air-permeable region 22 such that each flow-dividing tube 212 can exhaust hot air to the enhanced air-permeable region 22.

According to the present invention, as shown in FIG. 2a to 2d, the blowing model 1 is an upper half model la formed by simulating the shape of upper-half human body, which includes an upper-half human body 11, a neck portion 12 and a pair of upper limb portions 13, and which is used for wearing wet clothing A thereon. The upper half model 1a has an enhanced air-permeable region 22 (as shown in FIGS. 2a and 2b) formed to correspond to the neckline portion A1, two middle portions A2 of the chest, the forepart A3 and both the cuff portions A4. The upper half model la contains an air chamber 211 therein, which is connected to the inner lower side of the air inlet pipe 10. The air chamber 211 introduces hot air from the air inlet pipe 10 through a flow-dividing main tube 21 so as to distribute the hot air to the plural flow-dividing tubes 212 and to direct respectively the hot air to the plural enhanced air-permeable region 22. A pair of flow-dividing tubes 212 are directed to the upper edge of the enhanced air-permeable region 22 at the cuff portions A4 of the clothing A, and a flow-dividing tube 212 is directed to the upper edge of the enhanced air-permeable region 22 at the front part A3 (as shown in FIG. 2c). The flow-dividing main tube 21 and the air chamber 211 are formed by sewing cloth having mesh density smaller than that of porous cloth of the model 1 or by sewing an air-proof cloth. In addition, a plurality of fastening tapes 101 are provided on the top end of the air inlet pipe 10 of the upper half model 1a, which is used to be tied and fixed on the air outlet of a heating device 50 such as a conventional blower. Cold air or hot air can be optionally blown into the model 1b according to the cloth material of the clothing A (as shown in FIG. 2d).

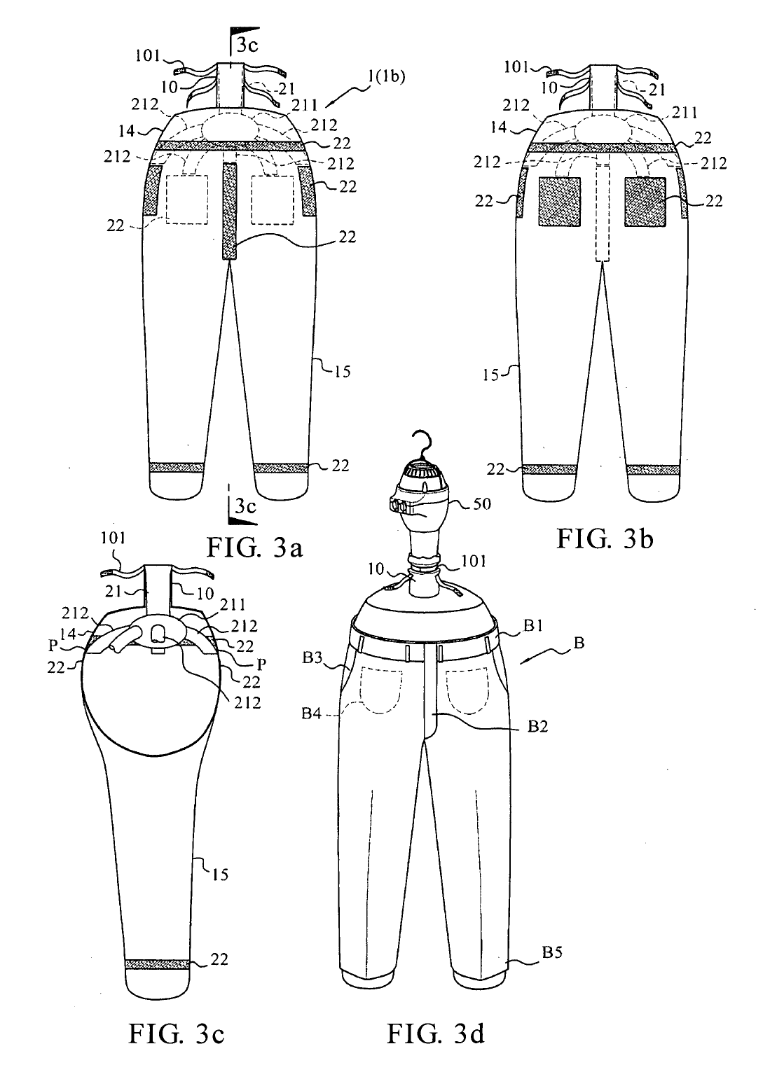

According to the present invention, as shown in FIG. 3a to 3d, the blowing model 1 is a lower half model 1b formed by simulating the shape of lower-half human body, which includes an lower-half human body 14 and a pair of lower limb portions 15, and which is used for wearing wet pant B thereon. The lower part model 1b has an enhanced air-permeable region 22 (as shown in FIGS. 3a and 3b) formed to correspond to the waistband portion B1 of pant B, the zipper shield portion B2, two side pocket portions B3, two rear pocket portions B4 and two pant cuff portions B5. The lower half model 1b contains an air chamber 211 therein, which is connected to the inner lower side of the air inlet pipe 10. The air chamber 211 introduces hot air from the air inlet pipe 10 through the flow-dividing main tube 21 so as to distribute the hot air to the plural flow-dividing tubes 212 and to direct the hot air to the plural enhanced air-permeable regions 22. A flow-dividing tubes 212 is directed to the upper edge of the enhanced air-permeable region 22 at the zipper shield portion B2 of the pant B, a pair of flow-dividing tubes 212 are directed respectively to the upper edge of the enhanced air-permeable region 22 at both side pocket portions B3, and a pair of flow-dividing tubes 212 are directed respectively to the upper edge of the enhanced air-permeable region 22 at both rear pocket portions B4 (as shown in FIG. 3c). The flow-dividing main tube 21 and the air chamber 211 are formed by sewing cloth having mesh density smaller than that of porous cloth of the model 1 or by sewing an air-proof cloth. In addition, a plurality of fastening tapes 101 are provided on the top end of the air inlet pipe 10 of the lower half model 1b, which is used to be tied and fixed on the air outlet of a heating device 50 such as a conventional blower. Cold air or hot air can be optionally blown inside the model 1b according to the cloth material of the pant B (as shown in FIG. 3d).

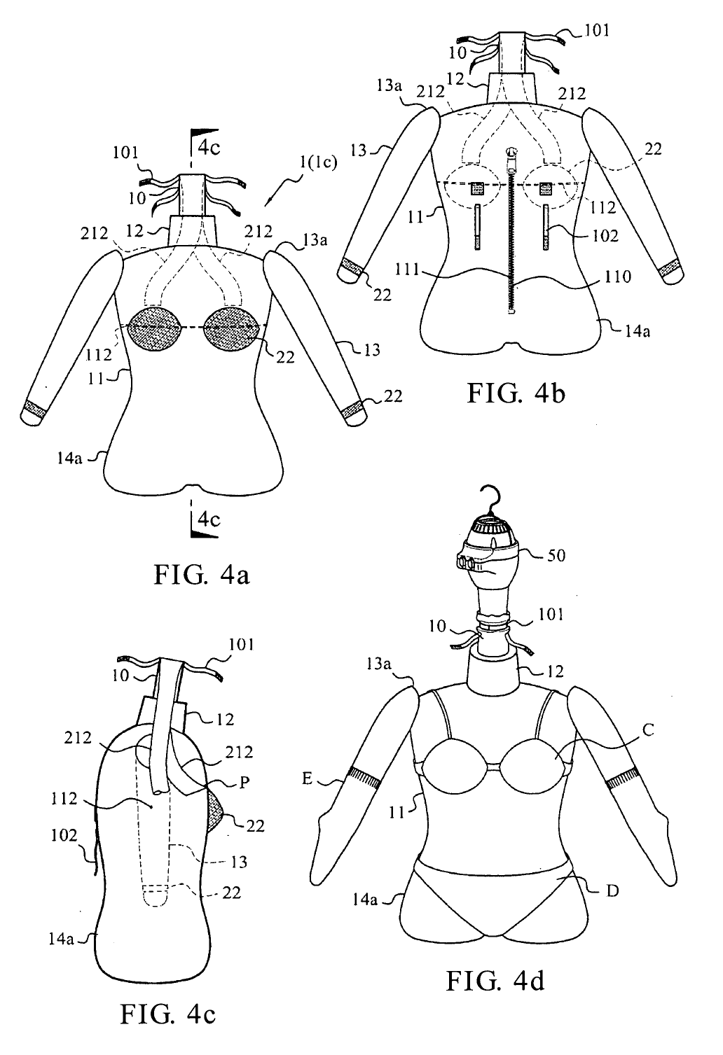

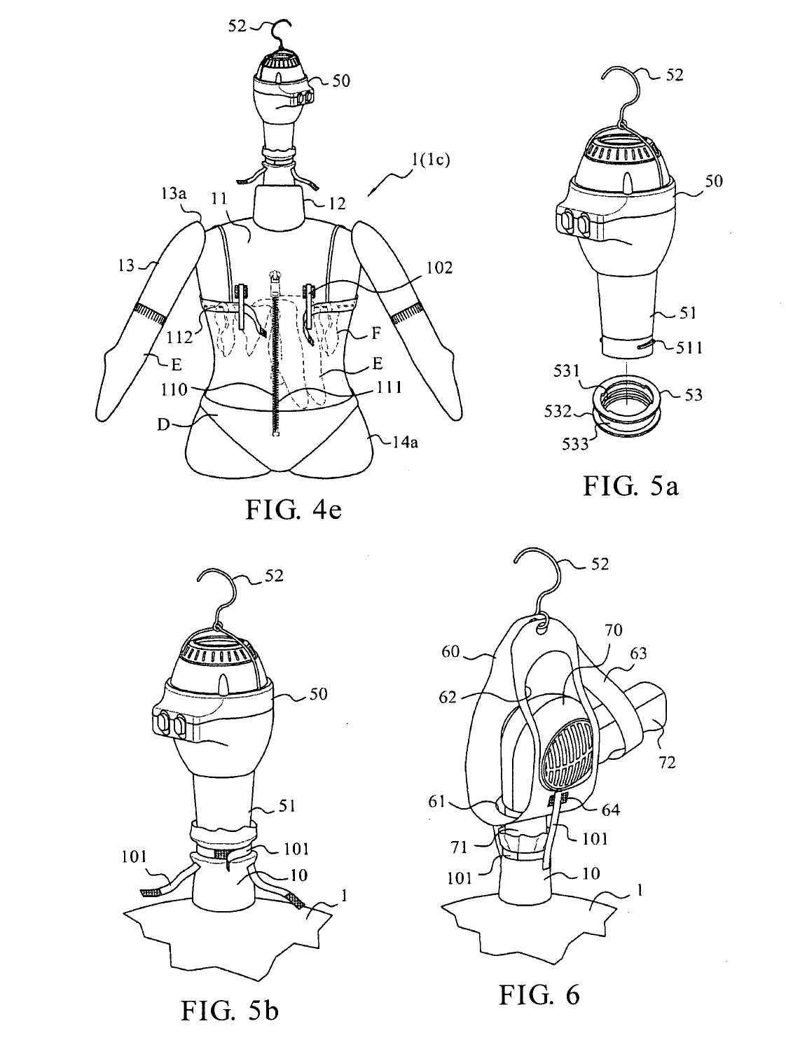

According to the present invention, as shown in FIG. 4a to 4e, the blowing model 1 is a whole model 1c formed by simulating the shape of upper half human body and hip, which includes an upper-half human body 11, a neck portion 12 and a pair of upper limb portions 13 and a hip portion 14a, and which is used for wearing or hanging body stockings such as spaghetti strap clothing, underwear C, panty D, sock E and small accessories F. The whole model 1c forms a pair of enhanced air-permeable region 22 convexly formed to correspond to both chest portions of the underwear C, and one enhanced air-permeable region 22 at the end of each one of the pair of upper limb portions 13 (as shown in FIGS. 4a and 4b). Inside the whole model 1c, a pair of flow-dividing tubes are branched from the inner side of the air inlet pipe 10 for directing hot air to the upper edge of the enhanced air-permeable regions 22 of both chest portions. The whole model 1c is provided with a pair of upper limb portions 13 with circumference having small diameter for wearing wet socks E thereon, and a pair of upwardly protruding shoulder portions 13a formed at the upper left and right sides for hanging spaghetti strap clothing, panty C and so forth to protect the strap from slipping off. Furthermore, The whole model 1c is provided with a fastening tape 102 at the rear left and right side respectively, for attaching to the fastening tape on the back of the panty C in case the size of the panty C does not match with that of the whole model 1c. A plurality of fastening tapes 101 are provided on the top end of the air inlet pipe 10 of the whole model 1c, for being tied and fixed on the air outlet of the heating device 50 such as a conventional blower. Cold air or hot air can be optionally blown inside the model 1 according to the cloth material of the clothing (as shown in FIG. 4d). In addition, a vertical opening 111 closed by a zipper 110 is formed on the back of the whole model 1c, in which at least one hanging string 112 traversing the left and right directions is provided. Alternatively, the underwear C, the panty D, the sock E and the small accessories F can be hung on the hanging string 112 for simultaneous drying (as shown in FIG. 4e).

FIGS. 5a and 5b show the heating device 50 of the present invention. The heating device 50, like a conventional blower, has an air outlet 51 and can selectively blow out cold air, warm air or hot air. A hanger 52 is provided on the top end of the heating device 51 for hanging the blower. A connecting member 53 is connected with the bottom end of the heating device 51, so as to be stably connected with the air inlet pipe 10 of the blowing model 1. As shown in FIG. 5a, several thread portions 511 are provided outside the air outlet 51 of the heating device 50, and several thread grooves 531 are formed on the inner bore of the connecting member 53 so as to be engaged with the thread portions 511. On the outer periphery of the connecting member 53, an annular depressed portion 533 is formed between the upper and the lower flanges 532. When in use, the air inlet pipe 10 of the blowing model 1 is inserted in the periphery of the connecting member 53, then a pair of fastening tapes 101 provided outside the air inlet pipe 10 are wound around the depressed portion 533 of the connecting member 53 (as shown in FIG. 5b), so as to secure a stable connection.

FIG. 6 illustrates that the blowing model 1 of the present invention used by a frequent traveler is combined with an ordinary blower 70 by a hanging string 60. It means that a frequent traveler obtains means from local source, such as a blower 70 provided by a hotel for drying and ironing out clothing by himself/herself. The hanging string 60, for example, has a through hole 61 in the middle for the penetration of the air outlet 71 and for the support of the blower 70. Both ends of the hanging string 60 are connected with a hanger 52 for hanging. Hollow portions 62 are provided respectively to correspond to both sides of the blower 70 for air circulation. A branch side strap 63 is provided for holding the handle 72 of the blower 70 in place so as to keep the balance of the blower 70. Furthermore, a fastening tape 64 is provided at an appropriate position of both sides of the hanging strap respectively. When in use, the air inlet pipe 10 of the blowing model 1 is penetrated through and fixed outside the air outlet 71 of the blower 70, is fastened tightly in a horizontal direction by a pair of fastening tapes 101 provided on the periphery of the air inlet pipe 10, and is adhered vertically to the fastening tapes 64 on both sides of the hanger 60 such that a stable connection can be achieved.

In sum, the blowing model of the present invention uses an ordinary blower to blow hot air through the air inlet pipe. After the closed model is inflated to an extent of tension, the hot air begins to permeate out from the gaps between the cloth fibers and carry away the water molecules existing between the cloth fibers. Therefore, clothing can be dried quickly and maintained in an ironed state, so that the time and the power consumed in ironing can be saved. Furthermore, the blowing model can be folded and stored so as to conserve occupied space. It is convenient for a traveler to carry and do the drying and ironing of clothing by himself/herself due to good portability. Thus, it is certainly a novel, progressive invention with good utility in industry.

While the present invention has been described with preferred embodiments in conjunction with the accompanying drawings, the preferred embodiments and the drawings are purely for the convenience of description only, and are not intended to be restrictive of the scope of the present invention. It is noted that various modifications and variations can be made without departing from the spirit of the present invention. In this case, these modifications and variations are considered to be within the scope of the present invention.

What is claimed is:

1. A flow-dividing device of a blowing model for drying and ironing out clothing, comprising an air inlet pipe formed on the top of the model, and a heating device connected to an outer end of the air inlet pipe for blowing air into the blowing model, wherein the blowing model is made by sewing porous cloth to form a closed model corresponding to a human body for wearing wet clothing thereon, and the flow-dividing device is characterized in that a plurality of flow-dividing tubes are provided within the blowing model, one end of each flow-dividing tube is branched from an inner side of the air inlet pipe, and the other end of each flow-dividing tube is directed respectively to an inner side corresponding to a plurality of laminated portions of the clothing.

2. A flow-dividing device of a blowing model as claimed in claim 1, wherein the blowing model has a plurality of enhanced air-permeable regions corresponding to a plurality of laminated portions of the clothing, the enhanced air-permeable regions are formed by a cloth having mesh density slightly larger than that of the porous cloth used for the blowing model.

3. A flow-dividing device of a blowing model as claimed in claim 2, wherein one end point of an end of each flow-dividing tube is fixed respectively on an upper edge of an inner side of each said enhanced porous region.

4. A flow-dividing device of blowing model as claimed in claim 3, wherein the plural flow-dividing tubes are formed by sewing a cloth having mesh density smaller than that of the porous cloth used for the blowing model, or by sewing an air-proof cloth.

5. A flow-dividing device of a blowing model as claimed in claim 4, wherein the blowing model is an upper half model formed by simulating the shape of an upper-half human body and comprises an upper-half human body, a neck portion and a pair of upper limb portions for wearing wet clothing thereon.

6. A flow-dividing device of a blowing model as claimed in claim 5, wherein the upper half model has an enhanced porous region formed to correspond to a neckline portion, two chest portions, a forepart and two cuff portions respectively.

7. A flow-dividing device of blowing model as claimed in claim 6, wherein the upper half model comprises an air chamber connected to an inner lower side of the air inlet pipe, the air chamber introduces hot air from the air inlet pipe through a flow-dividing main tube so as to distribute the hot air to the plural flow-dividing tubes and to direct the hot air respectively to the plural enhanced air-permeable regions.

8. A flow-dividing device of a blowing model as claimed in claim 7, wherein a pair of flow-dividing tubes are directed to an upper edge of the enhanced air-permeable region at the cuff portion of the clothing, and a flow-dividing tube is directed to an upper edge of the enhanced air-permeable region at the forepart.

9. A flow-dividing device of a blowing model as claimed in claim 8, wherein a plurality of fastening tapes are provided on a top end of said air inlet pipe of the upper half model for being tied and fixed on the air outlet of the heating device.

10. A flow-dividing device of a blowing model as claimed in claim 1, wherein the heating device is a blower and selectively blows cold air or hot air into the model.

11. A flow-dividing device of a blowing model as claimed in claim 4, wherein the blowing model is a lower half model formed by simulating the shape of a lower-half human body and includes an lower-half human body and a pair of lower limb portions for wearing a wet pant thereon.

12. A flow-dividing device of a blowing model as claimed in claim 11, wherein the lower half model forms an enhanced air-permeable region respectively to correspond to a waistband portion, a zipper shield portion, two side pocket portions, two rear pocket portions and two pant cuff portions.

13. A flow-dividing device of a blowing model as claimed in claim 12, wherein the lower half model comprises in an air chamber connected to an inner lower side of the air inlet pipe, the air chamber introduces hot air from the air inlet pipe through a flow-dividing main tube so as to distribute the hot air to said plural flow-dividing tubes and to direct the hot air to the plural enhanced air-permeable regions.

14. A flow-dividing device of a blowing model as claimed in claim 13, wherein one of the plural flow-dividing tube is directed to an upper edge of the enhanced air-permeable region at the zipper shield portion of the pant, a pair of flow-dividing tubes are directed respectively to an upper edge of the enhanced air-permeable region at both side pocket portions, and a pair of flow-dividing tubes directed respectively to an upper edge of the enhanced air-permeable region at the two rear pocket portions.

15. A flow-dividing device of a blowing model as claimed in claim 14, wherein a plurality of fastening tapes are provided on a top end of the air inlet pipe of the lower half model for being tied and fixed on the air outlet of the heating device.

16. A flow-dividing device of a blowing model as claimed in claim 4, wherein the blowing model is a whole model formed by simulating the shape of an upper-half human body and an hip and comprises an upper-half human body, a neck portion and a pair of upper limb portions and a hip portion for wearing body stockings thereon.

17. A flow-dividing device of a blowing model as claimed in claim 16, wherein said whole model has a pair of enhanced air-permeable regions convexly formed respectively on both chest portions.

18. A flow-dividing device of a blowing model as claimed in claim 17, wherein a pair of flow-dividing tubes inside the whole model are branched from an inner side of the air inlet pipe and directed respectively to an upper edge of the enhanced air-permeable regions of both chest portions.

19. A flow-dividing device of a blowing model as claimed in claim 18, wherein the whole model forms a pair of upwardly protruding shoulder portions for hanging spaghetti strap clothing, and forms a pair of upper limb portions with circumference having small diameter for wearing socks thereon.

20. A flow-dividing device of a blowing model as claimed in claim 19, wherein a vertical opening closed by a zipper is formed on the back of the whole model and at least has one hanging sting traversing the left and right directions.

21. A flow-dividing device of blowing model as claimed in claim 20, wherein a plurality of fastening tapes are provided on a top end of the air inlet pipe of the whole model for being tied and fixed on the air outlet of the heating device.
